(19) United States
(12) Patent Application Publication
(10) Pub. No.: US 2026/0087996 A1
(43) Pub. Date: Mar. 26, 2026

(54) DISPLAY DEVICE AND ELECTRONIC DEVICE USING THE SAME

(71) Applicant: Samsung Display Co., Ltd., Yongin-si (KR)

(72) Inventors: Kyung Ho KIM, Yongin-si (KR); Yun Mi KIM, Yongin-si (KR); Jung Hwan HWANG, Yongin-si (KR)

(21) Appl. No.: 19/096,483

(22) Filed: Mar. 31, 2025

(30) Foreign Application Priority Data
Sep. 20, 2024 (KR) 10-2024-0127370

(51) Int. Cl. G09G 3/3266; G09G 3/3233

(52) U.S. Cl. CPC G09G 3/3266; G09G 3/3233; G09G 2300/0842; G09G 2310/08; G09G 2340/0435

(57) ABSTRACT

A display device includes: a plurality of pixels on a display panel; a display driving circuit controlling data voltages supplied to the pixels and image display timing of the pixels; and a scan drive circuit driving gate lines of the display panel, wherein the scan drive circuit includes: an n-th stage configured to enable a pull-up node for each of odd and even frame periods in response to gate control signals from the display driving circuit; a plurality of output control units configured to share a pull-up node of the n-th stage and to supply gate scan signals to the gate lines in response to line select signals from the display driving circuit; and a node voltage control unit configured to control a voltage magnitude of a gate-on voltage charged to the pull-up node during the enable period in response to a pull-up control signal from the display driving circuit.

### CROSS-REFERENCE TO RELATED APPLICATION

The present application claims priority to and the benefit of Korean Patent Application No. 10-2024-0127370, filed on Sep. 20, 2024, in the Korean Intellectual Property Office, the entire disclosure of which is incorporated herein by reference.

### BACKGROUND

### 1. Field

Aspects of some embodiments of the present disclosure relate to a display device and electronic device using the same.

### 2. Description of the Related Art

As an information society develops, the demand for a display device for displaying an image is increasing in various forms. For example, display devices are applied to various electronic devices such as smartphones, digital cameras, laptop computers, navigation devices, and smart televisions.

The display device may be a flat panel display device such as a liquid crystal display device, a field emission display device, an organic light emitting display device, or the like. Among the flat panel display devices, the organic light emitting display device may include a light emitting element in which each of the pixels of a display panel may emit light by itself, thereby displaying an image without a backlight unit providing the light to the display panel.

The display device includes a display panel having data lines, scan signal lines, and sensing signal lines, as well as a plurality of pixels connected to the data lines, the scan signal lines, and the sensing signal lines arranged in a matrix structure. In addition, the display device further includes a scan driver for supplying scan signals to the scan signal lines of the display panel, a sensing driver for supplying sensing signals to the sensing signal lines, and a data driver for supplying data voltages to the data lines.

The display device may display images at 60 frames per second, 120 frames per second, or 180 frames per second on the display panel at a driving frequency rate of 60 Hz, 120 Hz, or 180 Hz. To this end, the driving circuits, such as the scan driver, the sensing driver, and the data driver, output the scan signals, the sensing signals, and the image data voltages according to the preset driving frequency rate. However, there was a limit to driving the display panel at a higher driving frequency as a screen became larger.

The above information disclosed in this Background section is only for enhancement of understanding of the background and therefore the information discussed in this Background section does not necessarily constitute prior art.

### SUMMARY

Aspects of the present disclosure provide a display device capable of implementing high-resolution images by increasing a frame frequency size of a display panel, i.e., an image display rate, and displaying images of the same frame for each of odd and even frame periods.

Aspects of the present disclosure also provide a display device capable of preventing or relatively reducing degradation in an image quality of high-resolution images by shifting and driving dual gate lines adjacent to each other for each of odd and even frame periods while performing a dual gate line driving method.

However, aspects of the present disclosure are not restricted to those set forth herein. The above and other aspects of the present disclosure will become more apparent to one of ordinary skill in the art to which the present disclosure pertains by referencing the detailed description of the present disclosure given below.

According to an aspect of the present disclosure, there is provided a display device including: a plurality of pixels arranged in a display area of a display panel; a display driving circuit controlling data voltages supplied to the plurality of pixels and image display timing of the pixels; and a scan drive circuit driving gate lines of the display panel, wherein the scan drive circuit includes: an n-th stage enabling a pull-up node for each of odd and even frame periods in response to gate control signals from the display driving circuit; a plurality of output control units sharing a pull-up node of the n-th stage and supplying gate scan signals to the gate lines in response to line select signals from the display driving circuit; and a node voltage control unit controlling a voltage magnitude of a gate-on voltage charged to the pull-up node during the enable period in response to a pull-up control signal from the display driving circuit.

According to another aspect of the present disclosure, there is provided a display device including: a plurality of pixels arranged in a display area of a display panel; a display driving circuit controlling data voltages supplied to the plurality of pixels and image display timing of the pixels; and a scan drive circuit driving gate lines of the display panel, wherein the scan drive circuit includes: an n-th stage enabling a pull-up node for each of odd and even frame periods in response to gate control signals from the display driving circuit; a plurality of output control units sharing a pull-up node of the n-th stage and supplying gate scan signals to the gate lines in response to line select signals from the display driving circuit; and a node voltage control unit controlling a voltage magnitude of a gate-on voltage charged to the pull-up node during the enable period in response to a pull-up control signal from the display driving circuit, and the display driving circuit generates the line select signals so that phases of the line select signals are differently shifted for each of the odd and even frame periods, and supplies the generated line select signals to the plurality of output control units for each of the odd and even frame periods.

According to an aspect of the present disclosure, there is provided an electronic device including a display device, wherein the display device comprising a plurality of pixels arranged in a display area of a display panel, a display driving circuit controlling data voltages supplied to the plurality of pixels and image display timing of the pixels, and a scan drive circuit driving gate lines of the display panel, wherein the scan drive circuit includes an n-th stage enabling a pull-up node for each of odd and even frame periods in response to gate control signals from the display driving circuit, a plurality of output control units sharing a pull-up node of the n-th stage and supplying gate scan signals to the gate lines in response to line select signals from the display driving circuit, and a node voltage control unit controlling a voltage magnitude of a gate-on voltage charged to the pull-up node during the enable period in response to a pull-up control signal from the display driving circuit.

In a display device according to some embodiments, the plurality of output circuits that output the scan signals using the gate lines may be relatively improved to operate by sharing the pull-up node of each stage circuit. Further, it may be relatively improved so that the enable voltage (or charging voltage) is supplied and maintained at a stable magnitude to the pull-up node of each stage circuit. Accordingly, an area of the bezel area (or image non-display area) in which the scan driver and the sensing driver are formed may be relatively reduced, and degradation in an image quality due to changes in the voltage magnitude of the scan signals and the sensing signals may be prevented or relatively reduced.

Further, according to the display device according to the embodiments, high-resolution images may be implemented even on a large-screen display device, by increasing the driving frequency size and image display speed of the display panel and relatively improving the display of images of the same frame for each of odd and even frame periods.

Further, according to the display device according to the embodiments, the degradation in the image quality of high-resolution images may be prevented or relatively reduced, by the scan driver and the sensing driver driving the gate lines and the sensing lines in the dual gate line driving method, and shifting and driving the gate lines and the sensing lines adjacent to each other for each of odd and even frame periods.

However, the effects of the embodiments are not restricted to the one set forth herein. The above and other effects of the embodiments will become more apparent to one of daily skill in the art to which the embodiments pertain by referencing the claims.

### BRIEF DESCRIPTION OF THE DRAWINGS

The above and other aspects and features of the present disclosure will become more apparent by describing in detail embodiments thereof with reference to the attached drawings, in which:

FIG. 1 is a plan view illustrating a configuration of a display device according to some embodiments of the present disclosure;

FIG. 2 is a side cross-sectional view illustrating aspects of the display device of FIG. 1;

FIG. 3 is a block diagram illustrating an electrical connection relationship between a display panel and each driver illustrated in FIGS. 1 and 2;

FIG. 4 is an equivalent circuit diagram of an example of a pixel of the display panel illustrated in FIG. 3;

FIG. 5 is a block diagram illustrating a scan driver according to some embodiments of the present disclosure;

FIG. 6 is a circuit diagram illustrating aspects of an n-th stage and output circuits illustrated in FIG. 5;

FIG. 7 is a waveform diagram illustrating signals input and output to the n-th stage and the output circuits and a voltage magnitude of a pull-up node during an odd-numbered frame period; and

FIG. 8 is a waveform diagram illustrating signals input and output to the n-th stage and the output circuits and a voltage magnitude of a pull-up node during an even-numbered frame period.

### DETAILED DESCRIPTION

Aspects of some embodiments of the present disclosure will now be described more fully hereinafter with reference to the accompanying drawings, in which aspects of some embodiments of the present disclosure are shown. This disclosure may, however, be embodied in different forms and should not be construed as limited to the embodiments set forth herein. Rather, these embodiments are provided so that this disclosure will be thorough and complete, and will filly convey the scope of the disclosure to those skilled in the art.

It will also be understood that when a layer is referred to as being “on” another layer or substrate, it can be directly on the other layer or substrate, or intervening layers may also be present. The same reference numbers indicate the same components throughout the specification.

It will be understood that, although the terms “first,” “second,” etc. may be used herein to describe various elements, these elements should not be limited by these terms. These terms are only used to distinguish one element from another element. For instance, a first element discussed below could be termed a second element without departing from the teachings of the present disclosure. Similarly, the second element could also be termed the first element.

Each of the features of the various embodiments of the present disclosure may be combined or combined with each other, in part or in whole, and technically various interlocking and driving are possible. Each embodiment may be implemented independently of each other or may be implemented together in an association.

Hereinafter, aspects of some embodiments of the present disclosure will be described in more detail with reference to the accompanying drawings.

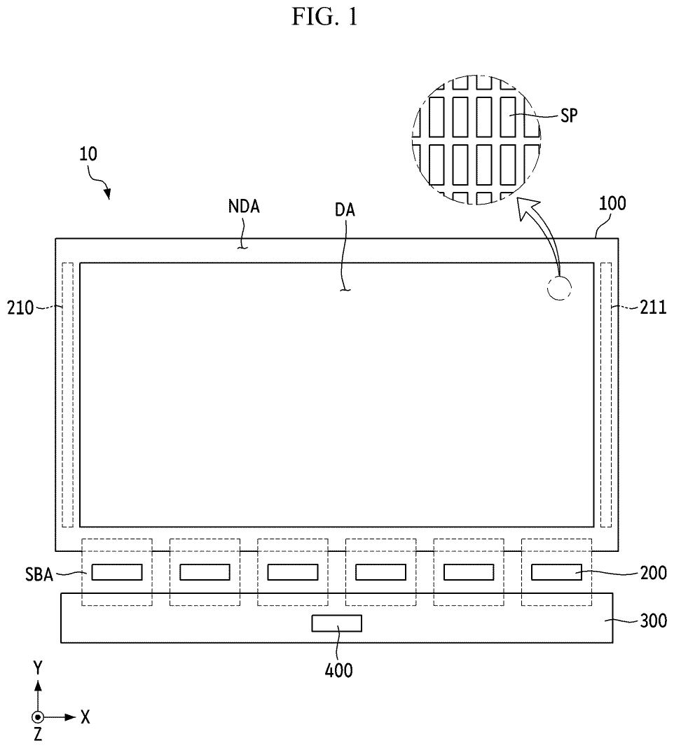

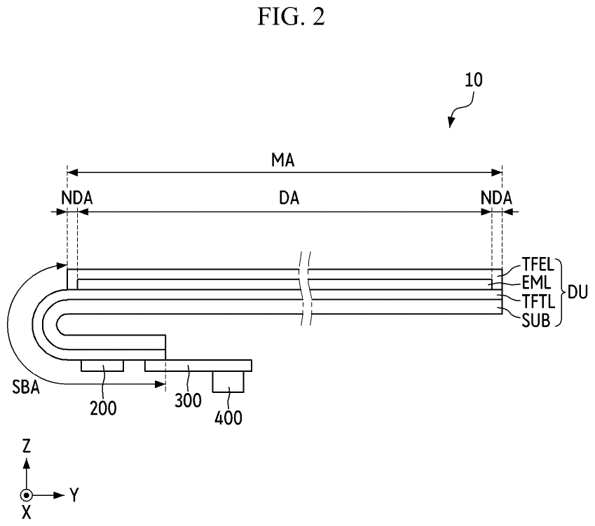

FIG. 1 is a plan view illustrating a configuration of a display device according to some embodiments of the present disclosure. In addition, FIG. 2 is a side cross-sectional view illustrating further details of the display device of FIG. 1.

Referring to FIGS. 1 and 2, a display device 10 according to some embodiments may be applied to a large image display device such as a television, a laptop, a monitor, a billboard, or Internet of Things (IOT). In addition, the display device 10 according to some embodiments may also be applied to portable electronic devices such as a tablet personal computer (PC), a portable multimedia player (PMP), a navigation device, an ultra mobile PC (UMPC), an e-book, an e-notebook, a mobile phone, a smart phone, a mobile communication terminal, etc.

The display device 10 according to some embodiments may be variously classified according to a display method. For example, the display device 10 may be classified into and configured as a micro LED display device (micro-LED), a nano LED display device (nano-LED), a liquid crystal display device (LCD), a plasma display device (PDP), a field emission display device (FED), an electrophoretic display device (EPD), an organic light emitting diode display device (OLED), an inorganic EL, a quantum dot emitting display device (QED), etc. Hereinafter, an organic light emitting diode display (OLED) will be described as an example of the display device 10 according to some embodiments, and unless a special distinction is required, the organic light emitting diode display (OLED) applied to the embodiments will be abbreviated as the display device 10. The display device 10 according to some embodiments is not limited to the organic light emitting diode display (OLED), and other display devices listed above or known in the art may be applied within the scope of sharing technical spirits.

The display device 10 according to some embodiments may have a rectangular shape, a square shape, a circular shape, an elliptical shape, or a quadrate shape in a plan view. For example, when the display device 10 is a large image display device such as a monitor, a television, or a laptop, the display device 10 may have a rectangular shape with long sides positioned in a horizontal direction. However, embodiments according to the present disclosure are not limited thereto, and when the display device 10 is applied to a mobile device such as a tablet PC, the long sides may be positioned in a vertical direction, and the display device 10 may be rotatably installed, such that the long sides may also be variably positioned in the horizontal or vertical direction.

The display device 10 includes a display panel 100, a scan driver, a data driving circuit 200, and a display driving circuit 400. Here, the scan driver includes first and second scan drive circuits 210 and 211. Here, the first scan drive circuit 210 is a gate scan driver that drives gate lines, and the second scan drive circuit 211 is a sensing scan driver that drives sensing lines. In addition, the data driving circuit 200 may include a plurality of data drivers formed in an integrated circuit type. Meanwhile, the display device 10 may further include a touch sensing unit, etc. formed in a front direction of the display panel 100.

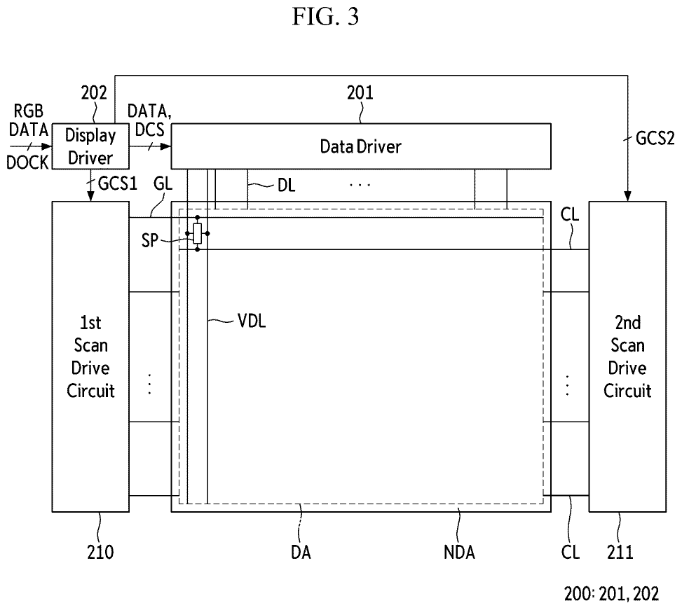

The display panel 100 of the display device 10 includes a display unit DU for displaying an image, and the touch sensing unit for sensing a touch of a body portion such as a finger and an electronic pen may be located on the display panel 100. The display unit DU of the display panel 100 may include a plurality of pixels SP and display an image through the plurality of pixels SP. Although FIG. 3 illustrates a single pixel SP, as a person having ordinary skill in the art would appreciate, the display panel 100 may include any suitable number of pixels SP according to the design and size of the display panel 100.

In addition, the touch sensing unit may be mounted on a front portion of the display panel 100 or formed integrally with the display panel 100.

The first scan drive circuit 210 supplies a gate scan signal to pixels SP for each horizontal line through gate lines for each horizontal line of the display unit DU based on a first gate control signal from the display driving circuit 400. The first scan drive circuit 210 sequentially supplies gate scan signals to the gate lines for each horizontal line to sequentially drive the pixels SP for each horizontal line.

The second scan drive circuit 211 supplies sensing control signals to the pixels SP for each horizontal line through sensing lines for each horizontal line of the display unit DU based on a second gate control signal from the display driving circuit 400. The second scan drive circuit 211 sequentially supplies the sensing control signals to the sensing lines for each horizontal line to control a pixel driving voltage of each pixel SP for each horizontal line to be output to the data driving circuit 200.

The data driving circuit 200 may include a plurality of data drivers formed in an integrated circuit type, i.e., a plurality of data driving integrated circuits. The data driving circuit 200 outputs data voltages according to image data to the pixels SP of the display unit DU based on a data driving control signal from the display driving circuit 400. For example, the data driving integrated circuits may supply the data voltages to the data lines connected to each pixel SP in units of horizontal lines for each horizontal cycle. For example, the data driving circuit 200 may supply a compensation data voltage to each pixel SP by receiving a pixel driving voltage of each pixel SP and performing data compensation processing according to the magnitude of the pixel driving voltage.

The display driving circuit 400 may operate as a main processor or may be formed integrally with the main processor. Accordingly, the display driving circuit 400 may control the overall function of the display device 10. For example, the display driving circuit 400 aligns image data from the outside and supplies the aligned image data to the data driving integrated circuits of the data driving circuit 200, and controls a driving timing of the data driving circuit 200. In addition, the display driving circuit 400 controls a gate scan signal output timing of the first scan drive circuit 210 and a sensing control signal output timing of the second scan drive circuit 211. In addition, the display driving circuit 400 may generate data control signals to control a data voltage output timing of the data driving integrated circuits included in the data driving circuit 200.

Referring to FIG. 2, the display panel 100 may be divided into a main area MA and a sub-area SBA. The main area MA may include a display area DA having the pixels SP displaying an image, and a non-display area NDA arranged around (e.g., in a periphery or outside a footprint of) the display area DA. In the display area DA, light may be emitted from light emitting areas or opening areas of each pixel SP to display an image. To this end, the pixels SP of the display area DA may include a pixel circuit including switching elements, a pixel defining layer defining the light emitting area or the opening area, and a self-light emitting element.

The non-display area NDA may be any outer area of the display area DA or an area outside the display area DA. The non-display area NDA may be defined as an edge area of the main area MA of the display panel 100. In the non-display area NDA, fan-out lines connecting the first and second scan drive circuits 210 and 211, the data driving circuit 200, and the display driving circuit 400 to the display area DA may be formed.

The first and second scan drive circuits 210 and 211 may be separately formed on one side and the other side of the display area DA, respectively. Unlike this, the first and second scan drive circuits 210 and 211 may be formed to be adjacent to each other on one side of the display area DA, and may be formed to be parallel and adjacent to each other on the other side of the display area DA.

The sub-area SBA may extend from one side of the main area MA. The sub-area SBA may be formed of a film of a flexible material that may be bent, folded, rolled, or the like. For example, when the sub-area SBA is bent, the sub-area SBA may overlap the main area MA in a thickness direction (Z-axis direction). The sub-area SBA may include the data driving circuit 200 and a pad portion connected to the circuit board 300. Optionally, the sub-area SBA may be omitted, and the data driving circuit 200 and the pad portion may also be located in the non-display area NDA.

The data driving circuit 200 may be formed as a plurality of integrated circuit (IC) and mounted on the display panel 100 by a chip on glass (COG) method, a chip on plastic (COP) method, or an ultrasonic bonding method. For example, the data driving circuit 200 may be located in a sub-area SBA, and may overlap the main area MA in the thickness direction (Z-axis direction) by bending of the sub-area SBA. As another example, the data driving circuit 200 may also be mounted on the circuit board 300.

The circuit board 300 may be electrically connected to the pad portion of the display panel 100 by an anisotropic conductive film (ACF). To this end, lead lines of the circuit board 300 may be electrically connected to the pad portion of the display panel 100. The circuit board 300 may be a flexible film such as a flexible printed circuit board, a printed circuit board, or a chip on film.

Meanwhile, the display driving circuit 400 may be mounted on the circuit board 300. The display driving circuit 400 may be formed as an integrated circuit (IC).

FIG. 3 is a block diagram illustrating an electrical connection relationship between a display panel and each driver illustrated in FIGS. 1 and 2.

Referring to FIG. 3, a plurality of pixels SP are arranged in a matrix structure in the display area DA. In addition, in the display area DA and the non-display area NDA, a plurality of gate lines GL connected to the pixels SP of each horizontal line for each horizontal line and a plurality of sensing lines CL connected to the pixels SP of a horizontal line for each horizontal line are arranged.

The plurality of gate lines GL and the plurality of sensing lines CL may extend in an X-axis direction, which is a first horizontal direction, and be spaced apart from each other in a first vertical direction intersecting the first horizontal direction. The plurality of gate lines GL and the plurality of sensing lines CL may be arranged at regular intervals along the first vertical direction.

The first scan drive circuit 210 drives the gate lines GL in a dual gate driving method. For example, the first scan drive circuit 210 supplies the gate scan signal to the gate lines GL in different orders for each of odd and even frame periods based on a first gate control signal GCS1 supplied from the display driving circuit 400 for each of the odd and even frame periods.

As an example, the first scan drive circuit 210 simultaneously (or concurrently) outputs the gate scan signals to two gate lines GL adjacent to each other based on the first gate control signal GCS1 supplied in the odd frame period and sequentially outputs the gate scan signals every first or second horizontal period. In the odd frame period, the first scan drive circuit 210 may sequentially output the gate scan signals in units of a pair of gate lines located adjacent to each other in odd and even numbers, i.e., each pair of gate lines located on 2n−1-th and 2n-th (where n is a positive integer). Here, the gate scan signals output in the next horizontal period of the gate scan signals output simultaneously (or concurrently) to each pair of gate lines may be sequentially output so as to overlap previous gate scan signals in units of a half pulse width. Accordingly, in the odd-numbered frame periods, pixels SP located on the odd and even-numbered horizontal lines (2n−1-th and 2n-th horizontal lines) are simultaneously (or concurrently) supplied with the gate scan signals through a pair of gate lines located adjacent to each other.

In addition, the first scan drive circuit 210 outputs a gate scan signal to a gate line of a first horizontal line based on the first gate control signal GCS1 supplied in the even frame period and then simultaneously (or concurrently) outputs the gate scan signals to two gate lines adjacent to each other, unlike during the odd frame period. In this case, the first scan drive circuit 210 sequentially outputs the gate scan signals every first or second horizontal period.

In the even frame period, the first scan drive circuit 210 may output the gate scan signal to one gate line located in the first horizontal line, and may then sequentially output the gate scan signals in units of each pair of gate lines located in a pair of 2n-th and 2n+1-th (where n is a positive integer) adjacent to each other. In addition, the first scan drive circuit 210 may output the gate scan signal to one gate line located on the last horizontal line. Similarly, the gate scan signals output in the next horizontal period of the gate scan signals output simultaneously (or concurrently) to each pair of gate lines may be sequentially output so as to overlap previous gate scan signals in units of a half pulse width.

Accordingly, in the even-numbered frame periods, the pixels SP located on the first horizontal line are supplied with the gate scan signal through one gate line, and the pixels SP located adjacent to each other on the 2n-th and 2n+1-th horizontal lines are simultaneously (or concurrently) supplied with the gate scan signals through the 2n-th and 2n+1-th gate lines. The pixels SP located on the last horizontal line may be supplied with the gate scan signals through one gate line located on the last horizontal line.

The second scan drive circuit 211 may control each pixel SP so that the pixel driving voltage and current of each pixel SP are output to each voltage detection line for each horizontal line. To this end, the second scan drive circuit 211 supplies sensing control signals to the sensing lines CL based on a second gate control signal GCS2 supplied from the display driving circuit 400 for each of the odd and even-numbed frame periods. The second scan drive circuit 211 may supply the sensing signals to the sensing lines CL in the same dual gate driving method as the first scan drive circuit 210. The plurality of sensing lines CL sequentially supply the sensing control signals output from the second scan drive circuit 211 to the plurality of pixels SP for each at least one horizontal line. Hereinafter, an output order of the sensing signal according to the dual gate driving method of the second scan drive circuit 211 will be replaced with the description of the dual gate driving method of the first scan drive circuit 210.

Meanwhile, the gate scan signals of the first scan drive circuit 210 and the sensing signals of the second scan drive circuit 211 may be alternately generated at different timings for each horizontal period. For example, in units of each horizontal period, the gate scan signal may first be supplied to the gate line GL, and in units of the next horizontal period, the sensing signal may also be supplied to the compensation sensing line CL.

In addition, in the display area DA and the non-display area NDA, a plurality of data lines DL connected pixels SP of each vertical line for each vertical line are arranged, and are electrically connected to the data driving circuit 200. The data voltage may determine emission luminance of each of the plurality of pixels SP. Furthermore, in the display area DA and the non-display area NDA, a plurality of voltage detection lines VDL connected pixels SP of each vertical line for each vertical line are arranged, and are electrically connected to the data driving circuit 200. The pixels SP of each horizontal line share the pixel driving voltage to each voltage detection line VDL in response to the compensation sensing control signal input in units of horizontal periods. Accordingly, the data driving circuit 200 receives the pixel driving voltage and current of each pixel SP in units of horizontal lines through each voltage detection line VDL.

For example, the data driving integrated circuits of the data driving circuit 200 may receive and sense pixel driving voltages and currents for pixels SP in units of horizontal lines for each horizontal cycle through each voltage detection line VDL. As an example, the data driving integrated circuits may sequentially sense the pixel driving voltages and currents received from each pixel SP in units of horizontal lines for each horizontal period.

The data driving integrated circuits generate voltage sensing data or current sensing data by performing analog-to-digital modulation processing according to the magnitude of the sensed pixel driving voltage and current amount of each pixel SP. The data driving integrated circuits transmit the voltage and current sensing data to the display driving circuit 400 in units of at least one horizontal line.

The display driving circuit 400 receives digital image data RGB DATA and a frequency clock signal DOCK according to the frame driving frequency from an external graphic system or graphic control board. Here, the frequency clock signal DOCK may include dot clock pulses according to any one frame driving frequency, such as 120 Hz, 180 Hz, or 240 Hz. According to some embodiments of the present disclosure, an example of displaying an image by a frequency clock signal DOCK supplied to correspond to the frame drive frequency of 240 Hz according to a high-speed drive method will be described.

The display driving circuit 400 aligns the image data RGB DATA input from the outside in units of the number of frames according to a resolution of the display area DA and a half frequency of the frame driving frequency. In addition, the display driving circuit 400 copies image data for each frame and arranges and aligns the copied image data for each frame as image data for even-numbered frames.

That is, image data of odd-numbered frames are copied in the same manner and arranged and aligned as the image data of even-numbered frames. In this way, as the image data for each number of frames corresponding to the half frequency of the frame driving frequency is copied for each frame and additionally located in the even-numbered frames, the number of image data of the entire frames aligned in the display driving circuit 400 may be aligned to the same number as the frame driving frequency.

The display driving circuit 400 may time-division modulate the frequency clock signal DOCK according to the frame driving frequency of 120 Hz into a frequency clock signal DOCK of 240 Hz that is twice as fast. The display driving circuit 400 sequentially supplies the image data, each aligned in the odd and even-numbered frames to the data driving integrated circuits of the data driving circuit 200 by at least one horizontal line, based on the frequency clock signal DOCK according to the modulated frame driving frequency of 240 Hz. In addition, the display driving circuit 400 generates a data driving control signal DCS based on the modulated frequency clock signals DOCK to control an operation timing of the data driving circuit 200. In addition, the display driving circuit 400 generates first and second gate driving control signals GCS1 and GCS2 based on the frequency clock signals DOCK to control the operation timing of each of the first and second scan drive circuits 210 and 211.

The data driving integrated circuits of the data driving circuit 200 supply data voltages according to the image data DATA to the data lines DL of the display unit DU for each of the odd and even-numbered frame periods, based on the each data driving control signal DCS supplied for each of the odd and even-numbered frame periods. Here, the data driving integrated circuits may supply the data voltages to the data lines DL connected to each pixel SP in units of horizontal lines for each horizontal cycle. The image data DATA for each of the odd and even-numbered frame periods may be the same image data.

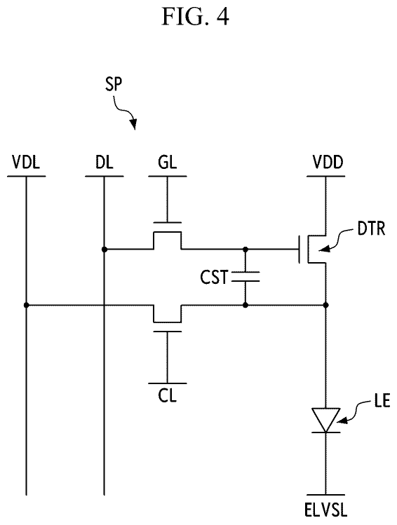

FIG. 4 is an equivalent circuit diagram of an example of a pixel of the display panel illustrated in FIG. 3. Although FIG. 4 illustrates various components in a pixel according to some embodiments, embodiments according to the present disclosure are not limited thereto, and according to various embodiments, the pixel may include additional components or fewer components without departing from the sprit and scope of embodiments according to the present disclosure

Referring to FIG. 4, each pixel SP may include two transistors STR and DTR for emitting light from the light emitting element LE, one storage capacitor CST, and a control transistor CTR for transmitting the pixel driving voltage supplied to the light emitting element LE to the voltage detection line VDL.

The driving transistor DTR adjusts the amount of current flowing from a first power line VDD to which a first power voltage is supplied to the light emitting element LE according to a voltage difference between a gate electrode and a source electrode thereof. The gate electrode of the driving transistor DTR may be connected to a first electrode of a first transistor T1, a first electrode thereof may be connected to the first power line VDD to which the first power voltage is applied, and a second electrode thereof may be connected a first electrode of the light emitting element LE.

The switching transistor STR is turned on by the gate scan signal of the gate line GL and supplies the data voltage of the data line DL to the gate electrode of the driving transistor DTR. A gate electrode of the switching transistor STR may be connected to one gate line GL, a first electrode thereof may be connected to the data line DL, and a second electrode thereof may be connected to the gate electrode of the driving transistor DTR.

The storage capacitor CST may be formed between the gate electrode and the second electrode of the driving transistor DTR. The storage capacitor CST stores a difference voltage between a gate voltage and a source voltage or a drain voltage of the driving transistor DTR.

The scan control transistor CTR is turned on by the sensing control signal of the sensing line CL and electrically connects the first electrode of the light emitting element LE and one of the voltage detection lines VDL. The pixel driving voltage may be supplied to the data driving circuit 200 through the voltage detection line VDL.

The switching transistor STR, the driving transistor DTR, and the scan control transistor CTR may be formed as thin film transistors. In addition, it is mainly described in FIG. 4 that the switching transistor STR, the driving transistor DTR, and the scan control transistor CTR are N-type metal oxide semiconductor field effect transistors (MOSFETs), but the present disclosure is not limited thereto. For example, the switching transistor STR, the driving transistor DTR, and the scan control transistor CTR are formed as P-type MOSFETs, or some may be formed as N-type MOSFETs and others as P-type MOSFETs.

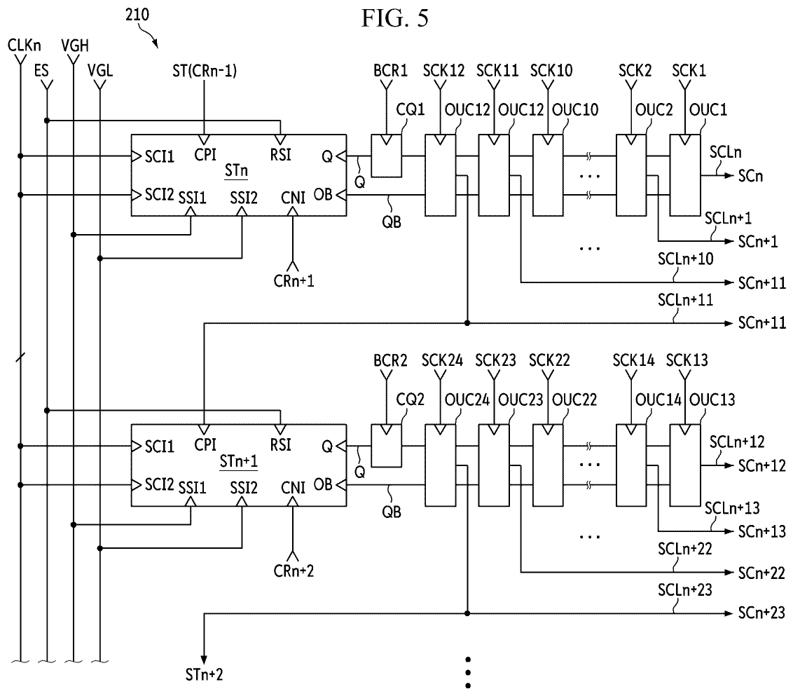

FIG. 5 is a block diagram illustrating a scan driver according to some embodiments of the present disclosure.

Referring to FIG. 5, the first scan drive circuit 210 according to some embodiments includes a plurality of stages that are cascadedly connected to each other, i.e., an n-th stage STn, a plurality of output control units OUC1 to OUC12, and at least one node voltage control units CQ1. Here, n is a positive integer.

For convenience of explanation, in FIG. 5, only an n+1-th stage STn+1 is illustrated based on the n-th stage STn. The n-th stages STn are cascadedly connected to each other. That is, in the case in which a plurality of n-th stages STn are formed, the n-th stages STn are cascadedly connected to each other. Here, the n+1-th stage STn+1 includes a plurality of output control units OUC13 to OUC24 and at least one node voltage control unit CQ2.

In the following description, “previous stage” refers to a stage located before the n-th stage STn, which is a reference stage. The “subsequent stage” refers to an n+1-th stage STn+1 located behind the n-th stage (STn), which is the reference stage.

Scan clock lines, to which are respectively applied with a plurality of scan clock signals CLKn whose phases are sequentially delayed or sequentially alternated, and gate control lines, to which are respectively applied with a start signal ST, a stage select signal ES, and a reset signal, may be respectively located on one side of all stages, including the n-th stage STn and the n+1-th stage STn+1.

The scan clock signals CLKn, the stage select signal ES, the start signal ST, the reset signal, a plurality of line select signals SCK1 to SCK24, and pull-up control signals BCR1 and BCR2 may be the first gate control signals GCS1 generated from the display driving circuit 400 and transmitted through the first gate control lines GSL1.

In FIG. 5, the first gate control lines GSL1 are illustrated as multi-channel line type scan clock lines, 24 line select signal SCK1 to SCK24 transmission lines, two carry select signal CRn+1 and CRn+2 transmission lines, two pull-up control signal BCR1 and BCR2 transmission lines, and two power lines, but the number of these lines is not limited to the drawing of FIG. 5 and may be formed in a greater number.

Each of all stages, including the n-th stage STn and the n+1-th stage STn+1 includes a front-end carry terminal CPI, a rear-end carry terminal CNI, a first scan clock terminal SCI1, a second scan clock terminal SCI2, a first power supply terminal SSI1, a second power supply terminal SSI2, a sensing signal terminal RSI, and a scan output terminal SCO.

When the n-th stage STn is a first stage, the start signal ST may be separately input to the carry terminal CPI in the front-end carry terminal CPI of the n-th stage STn through the start signal line. When the n-th stage STn is cascadedly connected to any of the previous stages, a carry signal CRn−1 of the previous stage is input to the front-end carry terminal CPI.

Each stage connected in a cascaded manner after the first stage receives each gate scan signal from any one carry output control unit OUC12 of the stage with the front-end carry terminal located immediately at the front end, as a carry signal.

For example, as illustrated in FIG. 5, the front-end carry terminal CPI of the n+1-th stage STn+1 may receive twelfth gate scan signal SCn+12 from the twelfth output control unit OUC12 of the n-th stage STn, as the carry signal.

The rear-end carry terminal CNI of each of all stages, including the n-th stage STn and the n+1-th stage STn+1, receives a gate scan signal from the output control unit of any one stage of the rear-end, as the carry signal. For example, the rear-end carry terminal CNI of the n-th stage STn may receive a gate scan signal from the twenty-fourth output control unit OUC24 of the n+1-th stage STn+1, as an n+1-th carry signal CRn+1.

The plurality of output control units OUC1 to OUC12 connected to the n-th stages STn, i.e., the first to twelfth output control units OUC1 to OUC12 shares a pull-up node Q of the n-th stage STn and is connected in a series or parallel structure to the pull-up node Q of the n-th stage STn.

An example is presented in which twelve first to twelfth output control units OUC1 to OUC12 are connected to the n-th stage STn, and twelve thirteenth to twenty-fourth output control units OUC13 to OUC24 are also connected in parallel to the n+1-th stage STn+1, but the number of output control units connected to each stage STn is not limited to FIG. 5 and may be differently applied depending on the resolution of the display panel 100.

The plurality of output control units OUC1 to OUC12 that share the pull-up node Q of the n-th stage STn output gate scan signals SCn in response to the first to twelfth line select signals SCK1 to SCK12 input for each of the odd and even-numbered periods from the display driving circuit 400.

For example, the first to twelfth output control units OUC1 to OUC12 that share the pull-up node Q of the n-th stage STn sequentially supply the 2n−1-th and 2n-th gate scan signals SCn and SCn+1, SCn+2 and SCn+3, SCn+4 and SCn+5, SCn+6 and SCn+7, SCn+8 and SCn+9, and SCn+10 and SCn+11 to the 2n−1-th and 2n-th (odd and even) gate lines, respectively, in response to the 2n−1-th and 2n-th (odd and even) line select signals SCK1 and SCK2, SCK3 and SCK4, SCK5 and SCK6, SCK7 and SCK8, SCK9 and SCK10, and SCK11 and SCK12 that are supplied simultaneously (or concurrently) in pairs, respectively, in an enable period (or charging period) of the pull-up node Q during the odd-numbered frame periods.

As an example, the first and second output control units OUC1 and OUC2 of the first to twelfth output control units OUC1 to OUC12 that share the pull-up node Q of the n-th stage STn simultaneously (or concurrently) output the n-th and n+1-th gate scan signals SCn and SCn+1 to the first and second gate lines through the n-th and n+1-th scan signal lines SCLn and SCLn+1, in response to the first and second line select signals SCK1 and SCK2 that are simultaneously (or concurrently) input for the first time during the enable period (or, charging period) of the pull-up node Q.

Next, the third and fourth output control units simultaneously (or concurrently) output the n+2-th and n+3-th gate scan signals to the third and fourth gate lines through the n+2-th and n+3-th scan signal lines, in response to the third and fourth line select signals that are simultaneously (or concurrently) input for the second time during the enable period of the pull-up node Q.

Next, the fifth and sixth output control units simultaneously (or concurrently) output the n+4-th and n+5-th gate scan signals to the fifth and sixth gate lines through the n+4-th and n+5-th scan signal lines, in response to the fifth and sixth line select signals that are simultaneously (or concurrently) input for the third time during the enable period of the pull-up node Q.

Next, the seventh and eighth output control units simultaneously (or concurrently) output the n+6-th and n+7-th gate scan signals to the seventh and eighth gate lines through the n+6-th and n+7-th scan signal lines, in response to the seventh and eighth line select signals that are simultaneously (or concurrently) input for the fourth time during the enable period of the pull-up node Q.

Next, the ninth and tenth output control units simultaneously (or concurrently) output the n+8-th and n+9-th gate scan signals to the ninth and tenth gate lines through the n+8-th and n+9-th scan signal lines, in response to the ninth and tenth line select signals SCK9 and SCK10 that are simultaneously (or concurrently) input for the fifth time during the enable period of the pull-up node Q.

Next, the eleventh and twelfth output control units simultaneously (or concurrently) output the n+8-th and n+9-th gate scan signals to the ninth and tenth gate lines through the n+8-th and n+9-th scan signal lines, in response to the ninth and tenth line select signals that are simultaneously (or concurrently) input for the fifth time during the enable period of the pull-up node Q.

The eleventh and twelfth output control units OUC11 and OUC12 output the n+10-th and n+11-th gate scan signals SCn+10 and SCn+11 to the eleventh and twelfth gate lines through the n+10-th and n+11-th scan signal lines SCLn+10 and SCLn+11, in response to the eleventh and twelfth line select signals SCK11 and SCK12 that are simultaneously (or concurrently) input for the sixth time during the enable period of the pull-up node Q.

Meanwhile, the thirteenth and fourteenth output control units OUC13 and OUC14 of the thirteenth to twenty-fourth output control units OUC13 to OUC24 that share the pull-up node Q of the n+1-th stage STn+1 outputs the n+12-th and n+13-th gate scan signals SCn+12 and SCn+13 to the thirteenth and fourteenth gate lines through the n+12-th and n+13-th scan signal lines SCLn+12 and SCLn+13, in response to the thirteenth and fourteenth line select signals SCK13 and SCK14 that are simultaneously (or concurrently) input for the first time during the enable period of the pull-up node Q.

Next, the fifteenth and sixteenth output control units simultaneously (or concurrently) output the n+14-th and n+15-th gate scan signals to the fifteenth and sixteenth gate lines through the n+14-th and n+15-th scan signal lines, in response to the fifteenth and sixteenth line select signals that are simultaneously (or concurrently) input for the second time during the enable period of the pull-up node Q.

In this way, the thirteenth to twenty-fourth output control units OUC13 to OUC24 that share the pull-up node Q of the n+1-th stage STn+1 sequentially output the 2n−1-th and 2n-th gate scan signals SCn+12 and SCn+13, SCn+14 and SCn+15, SCn+16 and SCn+17, SCn+18 and SCn+19, SCn+20 and SCn+21, and SCn+22 and SCn+23 units of the 2n−1-th and 2n-th gate lines, in response to the 2n−1-th and 2n-th line select signals SCK13 and SCK14, SCK15 and SCK16, SCK17 and SCK18, SCK19 and SCK20, SCK21 and SCK22, and SCK23 and SCK24, respectively, that are supplied simultaneously (or concurrently) for each of the 2n−1-th and 2n-th during the enable period of the pull-up node Q of the odd-numbered frame periods.

In the even-numbered frame periods, the first to twelfth output control units OUC1 to OUC12 that share the pull-up node Q of the n-th stage STn firstly supplies the first gate scan signal SCn to the first gate line, in response to the first line select signal SCK1 that is firstly generated during the enable period (or charging period) of the pull-up node Q.

Next, the second to eleventh output control units OUC2 to OUC11 sequentially supply the 2n-th and 2n+1-th gate scan signals SCn+1 and SCn+2, SCn+3 and SCn+4, SCn+5 and SCn+6, SCn+7 and SCn+8, and SCn+9 and SCn+10, respectively, in units of the 2n-th and 2n+1-th (even and odd) gate lines, in response to the 2n-th and 2n+1-th line select signals SCK2 and SCK3, SCK4 and SCK5, SCK6 and SCK7, SCK8 and SCK9, and SCK10 and SCK11, respectively, that are simultaneously (or concurrently) supplied for each of the 2n-th and 2n+1-th (even and odd).

Next, the twelfth output control unit OUC12 outputs the twelfth gate scan signal SCn+11 to the twelfth gate line, in response to one twelfth line select signal SCK12 that is supplied to the n-th stage STn for the seventh time.

As an example, the first output control unit OUC1 of the first to twelfth output control units OUC1 to OUC12 that share the pull-up node Q of the n-th stage STn outputs the n-th gate scan signal SCn to the first gate line through the n-th scan signal line SCLn, in response to one first line select signal SCK1 that is firstly input during the enable period (or, charging period) of the pull-up node Q.

Next, the second and third output control units OUC2 and OUC3 output the n+1-th and n+2-th gate scan signals SCn+1 and SCn+2 to the second and third gate lines through the second and third scan signal lines SCLn+1 and SCLn+2, in response to the 2n-th and 2n+1-th line select signals SCK2 and SCK3 that are simultaneously (or concurrently) supplied during the enable period of the pull-up node Q.

Next, the fourth and fifth output control units simultaneously (or concurrently) output the n+3-th and n+4-th gate scan signals to the fourth and fifth gate lines through the n+3-th and n+4-th scan signal lines, in response to the fourth and fifth line select signals that are simultaneously (or concurrently) input for the second time during the enable period of the pull-up node Q.

Next, the sixth and seventh output control units simultaneously (or concurrently) output the n+5-th and n+6-th gate scan signals to the sixth and seventh gate lines through the n+5-th and n+6-th scan signal lines, in response to the sixth and seventh line select signals that are simultaneously (or concurrently) input for the third time during the enable period of the pull-up node Q.

Next, the eighth and ninth output control units simultaneously (or concurrently) output the n+7-th and n+8-th gate scan signals to the eighth and ninth gate lines through the n+7-th and n+8-th scan signal lines, in response to the eighth and ninth line select signals that are simultaneously (or concurrently) input for the fourth time during the enable period of the pull-up node Q.

Next, the tenth and eleventh output control units OUC10 and OUC11 simultaneously (or concurrently) output the n+9-th and n+10-th gate scan signals SCn+9 and SCn+10 to the tenth and eleventh gate lines through the n+10-th and n+11-th scan signal lines, in response to the tenth and eleventh line select signals SCK10 and SCK11 that are simultaneously (or concurrently) input for the fifth time during the enable period of the pull-up node Q.

Next, the twelfth output control unit OUC12 outputs the n+11-th gate scan signal SCn+11 to the twelfth gate line through the n+11-th scan signal line SCLn+11, in response to one twelfth line select signal SCK12 that is lastly input during the enable period of the pull-up node Q.

Meanwhile, the thirteenth output control unit OUC13 of the thirteenth to twenty-fourth output control units OUC13 to OUC24 that share the pull-up node Q of the n+1-th stage STn+1 outputs the n+12-th gate scan signal SCn+12 to the thirteenth gate line through the thirteenth scan signal line SCLn+12, in response to one thirteenth line selection signal SCK13 that is firstly input during the enable period of the pull-up node Q.

Next, the fourteenth and fifteenth output control units OUC14 and OUC15 of the n+1-th stage STn+1 output the n+13-th and n+14-th gate scan signals SCn+13 and SCn+14 to the fourteenth and fifteenth gate lines through the fourteenth and fifteenth scan signal lines SCLn+13 and SCLn+14, in response to the 2n-th and 2n+1-th line select signals that are simultaneously (or concurrently) supplied during the enable period of the pull-up node Q.

In this way, the fifth to twenty-third output control units OUC15 to OUC23 of the n+1-th stage STn+1 supply the 2n-th and 2n−1-th gate scan signals SCn+14 and SCn+15, SCn+16 and SCn+17, SCn+18 and SCn+19, SCn+20 and SCn+21, and SCn+22 and SCn+23, respectively, in units of the 2n-th and 2n−1-th gate lines, in response to the 2n-th and 2n−1-th line select signals SCK14 and SCK15, SCK16 and SCK17, SCK18 and SCK19, SCK20 and SCK21, and SCK22 and SCK23 that are simultaneously (or concurrently) supplied for each of the 2n-th and 2n−1-th (even and odd), respectively, during the enable period of the pull-up node Q of the even-numbered frame periods.

Meanwhile, each of the node voltage control units CQ1 and CQ2 controls the charge voltage magnitude of the pull-up node Q for each stage, i.e., each n-th stage STn, in response to the pull-up control signals BCR1 and BCR2 from the display driving circuit 400.

For example, one first node voltage control unit CQ1 shares the pull-up node Q of the n-th stage STn and is connected in series or in parallel to the first to twelfth output control units OUC1 to OUC12. The second node voltage control unit CQ2 shares the pull-up node Q of the n+1-th stage STn+1 and is connected in series or in parallel to the thirteenth to twenty-fourth output control units OUC13 to OUC24.

Each of the node voltage control units CQ1 and CQ2 adjusts the voltage magnitude of the pull-up node Q according to the change in the voltage magnitude of the pull-up control signals BCR1 and BCR2 input from the display driving circuit 400 during the enable period of the pull-up node Q.

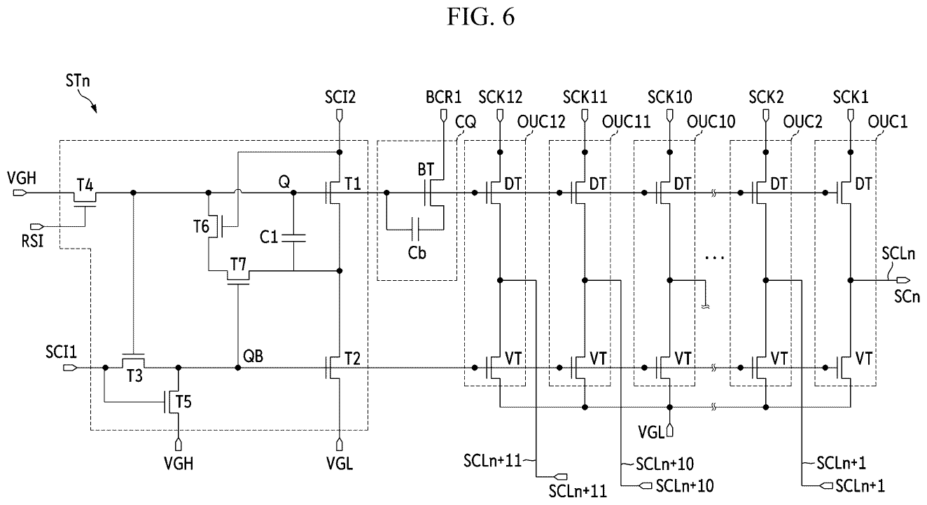

FIG. 6 is a circuit diagram illustrating further details of an n-th stage and output circuits illustrated in FIG. 5.

Referring to FIGS. 5 and 6, the n-th stage STn includes a first power supply terminal SSI1 supplied with a gate-on voltage VGH, and a second power supply terminal SSI2 supplied with a gate-off voltage VGL.

The n-th stage STn may operate by receiving the start signal ST through the front-end carry terminal CPI, and may operate by receiving any one gate scan signal of the previous stage as the carry signal through the front-end carry terminal CPI when it is cascadedly connected to the previous stage. In addition, the n-th stage STn may also operate sequentially in response to the stage select signal ES input during a preset active period.

The n-th stage STn supplies a voltage having the magnitude of the gate-on voltage VGH to the pull-up node Q during the active period of each frame period and controls the pull-up node Q as well as the plurality of output control units OUC1 to OUC12 to be enabled. Here, the active period of each n-th stage STn is preset according to the number of output control units OUC1 to OUC12 that share the pull-up node Q of each n-th stage STn.

As an example, when the first to twelfth output control units OUC1 to OUC12 are connected to the pull-up node Q of each n-th stage STn, the active period of each n-th stage STn may be at least twelve horizontal periods (or twelve horizontal line driving periods). In this way, while the pull-up node Q of each n-th stage STn is charged and maintained to the gate-on voltage VGH, the gate-off voltage VGL of the second power supply terminal SSI2 is applied to a pull-down node QB.

For example, the n-th stage STn operates in response to the stage select signal ES or the carry signal (or start signal ST) of the front-end stage, and supplies the gate-on voltage VGH to the pull-up node Q by being switched by the plurality of clock signals CLKn. Here, the stage select signal ES or the carry signal of the front-end stage may have the magnitude of the gate-on voltage. The pull-up node Q of the n-th stage STn is enabled depending on the magnitude of the gate-on voltage VGH when the gate-on voltage VGH is applied. The n-th stage STn ensures that the gate-off voltage VGL is applied to the pull-down node QB during the period in which the gate-on voltage VGH is supplied to the pull-up node Q.

As described above, the first to twelfth output control units OUC1 to OUC12 that share the pull-up node Q of the n-th stage STn output n-th to n+11-th scan signals SCn to SCn+11 to the n-th to n+11-th gate lines, in response to the first to twelfth line select signals SCK1 to SCK12 sequentially input during the enable period (or, charging period) of the pull-up node Q.

The node voltage control unit CQ1 adjusts the voltage magnitude of the pull-up node Q according to the change in the voltage magnitude of the pull-up control signal BCR1 input from the display driving circuit 400 during the enable period of the pull-up node Q.

After the n-th to n+11-th scan signals SCn to SCn+11 are output during the enable period of the pull-up node Q, the n-th stage STn supplies the gate-off voltage VGL to the pull-up node Q in response to any one of the carry signal of the front end and the clock signals CLKn. Accordingly, the pull-up node Q is disabled by the gate-off voltage VGL. In this case, the n-th stage STn enables the pull-down node QB to the gate-on voltage VGH in response to any one scan clock signal among the clock signals CLKn during a period in which the pull-up node Q is disabled.

When the pull-down node QB of the n-th stage STn is enabled, the first to twelfth output control units OUC1 to OUC12 electrically connect the n-th to n+11-th scan signal lines SCLn to SCLn+11 to the second power supply terminal SSI2 to which the gate-off voltage VGL is applied.

Referring to FIG. 6, the n-th stage STn according to some embodiments may include first to seventh transistors T1 to T7 and at least one first capacitor C1. One of a first electrode and a second electrode of each of the first to seventh transistors T1 to T7 may be a source electrode, and the other thereof may be a drain electrode.

A gate electrode of the first transistor T1 may be connected to the pull-up node Q, the first electrode of the first transistor T1 may be connected to the second scan clock terminal SCI2, and the second electrode thereof may be connected to the front-end carry terminal CPI and the first electrode of the second transistor T2. When the pull-up node Q is enabled by the gate-on voltage VGH, the first transistor T1 may be turned on and supply the plurality of clock signals CLKn that are sequentially supplied to the first capacitor C1 and the second transistor T2 that are connected in parallel.

A gate electrode of the second transistor T2 is connected to the pull-down node QB, and the first electrode thereof is connected to the second electrode of the first transistor T1 and the front-end carry terminal CPI. In addition, the second electrode of the second transistor T2 is connected to the second power supply terminal SSI2. When the pull-down node QB is enabled by the gate-on voltage VGH, the second transistor T2 is turned on and supplies the gate-off voltage VGL to the first transistor T1.

A gate electrode of the third transistor T3 is connected to the pull-up node Q, and the first electrode thereof is connected to the first scan clock terminal SCI1. In addition, the second electrode of the third transistor T3 is connected to the pull-down node QB. When the pull-up node Q is enabled by the gate-on voltage VGH, the third transistor T3 is turned on and supplies the plurality of clock signals CLKn to the pull-down node QB.

A gate electrode of the fourth transistor T4 is connected to the sensing signal terminal RSI or the front-end carry terminal CPI, and the first electrode thereof is connected to the first power supply terminal SSI1. In addition, the second electrode of the fourth transistor T4 is connected to the pull-up node Q. The fourth transistor T4 is turned on in response to the stage select signal ES or the front-end carry signal of the sensing signal terminal RSI and supplies the gate-on voltage VGH to the pull-up node Q. Accordingly, the fourth transistor T4 may enable the pull-up node Q to the magnitude of the gate-on voltage VGH during the active period in response to the stage select signal ES or the front-end carry signal of the sensing signal terminal RSI.

A gate electrode of the sixth transistor T6 is connected to the second scan clock terminal SCI2, and the first electrode thereof is connected to the pull-up node Q. In addition, the second electrode of the sixth transistor T6 is connected to the second electrode of the first transistor T1 or the first electrode of the seventh transistor T7. The sixth transistor T6 electrically connects the pull-up node Q to the second electrode of the first transistor T1 or the first electrode of the seventh transistor T7 in response to at least one clock signal CLKn. The sixth transistor T6 may serve as a diode between the pull-up node Q and the first capacitor C1.

A gate electrode of the seventh transistor T7 is connected to the pull-down node QB, and the first electrode thereof is connected to the second electrode of the sixth transistor T6. In addition, the second electrode of the seventh transistor T7 is connected to the second electrode of the first transistor T1 and the first capacitor C1. When the pull-down node QB is enabled, the seventh transistor T7 is turned on and electrically connects the second electrode of the sixth transistor T6 to the first capacitor C1 and the second electrode of the first transistor T1. The seventh transistor T7 serves as a diode to keep the sixth transistor T6 and the first transistor T1 turned off during the enable period of the pull-down node QB.

Each of the first to twelfth output control units OUC1 to OUC12 includes a pull-up transistor DT and a pull-down transistor VT.

A first electrode of the pull-up transistor DT is connected to each line select signal input terminal that receives one of the first to twelfth line select signals SCK1 to SCK12, and a gate electrode thereof is connected to the pull-up node Q. In addition, a second electrode thereof is connected to a scan signal line connection terminal of one of the n-th to n+11-th scan signal lines SCLn to SCLn+11.

For example, the pull-up transistor DT of the first output control unit OUC1 is turned on by the gate-on voltage VGH of the pull-up node Q and outputs a first line select signal SCK1 input to each first line select signal input terminal to an n-th scan signal line SCLn. As a result, an n-th scan signal SCn of the gate-on voltage may be supplied to the n-th scan signal line SCLn.

A first electrode of each pull-down transistor VT of the first to twelfth output control units OUC1 to OUC12 is connected to a scan signal line connection terminal of one of the n-th to n+11-th scan signal lines SCLn to SCLn+11, and a gate electrode thereof is connected to the pull-down node QB. In addition, a second electrode thereof is connected to the second power supply terminal SSI2.

The pull-down transistor VT is turned on by the gate-on voltage VGH of the pull-down node QB and applies the gate-off voltage VGL input to the second power supply terminal SSI2 to one of the scan signal lines SCLn to SCLn+11 each connected thereto. As a result, each of the scan signal lines SCLn to SCLn+11 may be maintained at the gate-off voltage VGL during the turn-on period of the pull-down transistor VT.

Each of the node voltage control units CQ1 and CQ2 includes a pull-up control transistor BT and a pull-up capacitor Cb.

The pull-up control transistor BT is turned on by the gate-on voltage VGH of the pull-up node Q and outputs a pull-up control signal BCR1 input to a first electrode to a second electrode.

A first electrode of the pull-up capacitor Cb is connected to the pull-up node Q in a parallel structure with the pull-up control transistor BT, and a second electrode thereof is connected to the second electrode of the pull-up control transistor BT.

When the pull-up control transistor BT of the node voltage control unit CQ is turned on by the gate-on voltage VGH of the pull-up node Q, it supplies the pull-up control signal BCR1 from the display driving circuit 400 to the second electrode of the pull-up capacitor Cb.

The pull-up capacitor Cb varies or maintains the voltage magnitude of the pull-up node Q connected to the first electrode depending on the voltage magnitude of the pull-up control signal BCR1 input to the second electrode.

Accordingly, each of the node voltage control units CQ1 and CQ2 adjusts the voltage magnitude of the pull-up node Q according to the change in the voltage magnitude of the pull-up control signals BCR1 and BCR2 input from the display driving circuit 400 during the enable period of the pull-up node Q.

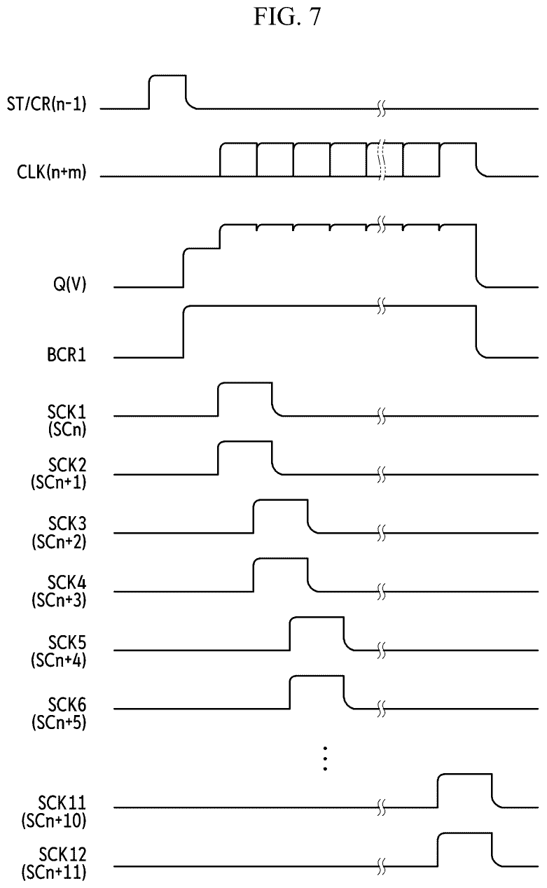

FIG. 7 is a waveform diagram illustrating signals input and output to the n-th stage and the output circuits and a voltage magnitude of a pull-up node during an odd-numbered frame period.

Referring to FIG. 7, the start signal ST, the stage select signal ES, the carry select signal CRK, the plurality of clock signals CLKn,. CLKm, etc. are signals that are generated at the magnitude of the gate-on voltage VGH for at least one horizontal period 1H.

The display driving circuit 400 generates the start signal ST, the plurality of clock signals CLKn, . . . CLKm, the first to n-th line select signals SCK1 to SCKn, and at least one pull-up control signal BCR1 using a separate pulse signal generator, etc.

The display driving circuit 400 supplies the start signal ST, the plurality of clock signals CLKn, . . . CLKm, the first to twelfth line select signals SCK1 to SCK12, and the first pull-up control signal BCR1 to the n-th stage STn.

A stage select signal ES, according to some embodiments, may be generated for one horizontal period 1H so that the gate-on voltage VGH may be supplied to the pull-up node Q of each of the stages STn and STn+1 during the active period. The stage select signal ES may be replaced by a carry signal from the previous stage (i.e., the rear-end carry signal CR(n−1)) even if it is not separately generated and supplied.

The gate-on voltage VGH may be a gate high voltage capable of turning on the transistors of the n-th stage STn and the first to twelfth output control units OUC1 to OUC12, and the transistors of the sub-pixels SP. The gate-off voltage VGL may be a gate low voltage capable of turning off the transistors of the n-th stage STn and the first to twelfth output control units OUC1 to OUC12, and the transistors of the sub-pixels SP.

The plurality of clock signals CLKn, . . . CLKm (where m is a natural number greater than n) are clock signals that are sequentially phase delayed or repeatedly generated. Each of the plurality of clock signals CLKn, . . . CLKm may be repeatedly generated with the magnitude of the gate-on voltage VGH for at least one horizontal period 1H. Here, the generation period, pulse width, and amplitude for each of the plurality of clock signals CLKn, . . . CLKm are not limited to FIG. 7 and may be changed in various ways.

The first to twelfth line select signals SCK1 to SCK12 may be repeatedly generated at the magnitude of the gate-on voltage VGH for each at least one horizontal period 1H. The first to twelfth line select signals SCK1 to SCK12 may be clock signals in which a phase is delayed by at least one horizontal period 1H and at least one signal is simultaneously (or concurrently) and repeatedly generated.

As an example, during the odd-numbered periods of the image display period, the display driving circuit 400 sequentially generates the 2n−1-th and 2n-th (odd and even-numbered) line select signals SCK1 and SCK2, SCK3 and SCK4, SCK5 and SCK6, SCK7 and SCK8, SCK9 and SCK10, and SCK11 and SCK12 so that the 2n−1-th and 2n-th (odd and even-numbered) line select signals SCK1 and SCK2, SCK3 and SCK4, SCK5 and SCK6, SCK7 and SCK8, SCK9 and SCK10, and SCK11 and SCK12 are paired and simultaneously (or concurrently) varied by the magnitude of the gate-on voltage VGH for each at least one horizontal period 1H. In addition, the display driving circuit 400 sequentially supplies the 2n−1-th and 2n-th (odd and even-numbered) line select signals SCK1 and SCK2, SCK3 and SCK4, SCK5 and SCK6, SCK7 and SCK8, SCK9 and SCK10, and SCK11 and SCK12 that are sequentially generated for each of the 2n−1-th and 2n-th (odd and even-numbered) to the 2n−1-th and 2n-th (odd and even-numbered) output control units OUC1 and OUC2, OUC3 and OUC4, OUC5 and OUC6, OUC7 and OUC8, OUC9 and OUC10, and OUC11 and OUC12 each corresponding to thereto.

Meanwhile, during the even-numbered frame periods of the image display period, the display driving circuit 400 generates one first line select signal SCK1 with the magnitude of the gate-on voltage VGH for at least one horizontal period 1H and supplies the generated first line select signal SCK1 to one output control unit OUC1. Next, the display driving circuit 400 sequentially generates the 2n-th and 2n+1-th (even and odd-numbered) line select signals SCK2 and SCK3, SCK4 and SCK5, SCK6 and SCK7, SCK8 and SCK9, and SCK10 and SCK11 so that the 2n-th and 2n+1-th (even and odd-numbered) line select signals SCK2 and SCK3, SCK4 and SCK5, SCK6 and SCK7, SCK8 and SCK9, and SCK10 and SCK11 are paired and simultaneously (or concurrently) varied for each at least one horizontal period 1H with the magnitude of the gate-on voltage VGH. In addition, the display driving circuit 400 sequentially supplies the 2n-th and 2n+1-th (even and odd-numbered) line select signals SCK2 and SCK3, SCK4 and SCK5, SCK6 and SCK7, SCK8 and SCK9, and SCK10 and SCK11 that are simultaneously (or concurrently) and sequentially generated for each of the 2n-th and 2n+1-th (even and odd-numbered) to the 2n-th and 2n+1-th (even and odd-numbered) output control units OUC2 and OUC3, OUC4 and OUC5, OUC6 and OUC7, OUC8 and OUC9, and OUC10 and OUC11 each corresponding thereto. Next, the display driving circuit 400 generates one twelfth line select signal SCK12 with the magnitude of the gate-on voltage VGH for at least one horizontal period 1H and supplies the generated twelfth line select signal SCK12 to one twelfth output control unit OUC12.

In this way, the display driving circuit 400 generates the plurality of line select signals SCK1 to SCK12 so that the phases of the plurality of line select signals SCK1 to SCK12 are shifted in units of the odd and even-numbered frame periods, and supplies the generated signals to the plurality of output control units OUC1 to OUC12.

Meanwhile, the display driving circuit 400 generates each of the pull-up control signals BCR1 and BCR2 to correspond to the period in which the pull-up node Q of each stage STn is enabled and sequentially supplies the pull-up control signals BCR1 and BCR2 to the node voltage control units CQ1 and CQ2 during the period in which the pull-up node Q of each stage STn is enabled.

The display driving circuit 400 generates the pull-up control signals BCR1 and BCR2 with a voltage magnitude equal to the magnitude of the gate-on voltage VGH or greater than the gate-on voltage VGH and sequentially supplies the pull-up control signals BCR1 and BCR2 to the node voltage control units CQ1 and CQ2 during the period in which the pull-up node Q of each stage STn is enabled.

Referring to FIGS. 6 and 7, an operation of the n-th stage STn during odd-numbered frame periods is briefly described as follows.

First, the fourth transistor T4 is turned on in response to the stage select signal ES or the start signal ST of the sensing signal terminal RSI and supplies the gate-on voltage VGH to the pull-up node Q. Accordingly, the pull-up node Q is enabled.

When the pull-up node Q is enabled by the gate-on voltage VGH, the first transistor T1 is turned on and charges the first capacitor C1. As a result, the pull-up node Q may be bootstrapped.

The display driving circuit 400 generates a first pull-up control signal BCR1 with a voltage magnitude equal to the magnitude of the gate-on voltage VGH or greater than the gate-on voltage VGH during the period when the pull-up node Q of the n-th stage STn is enabled and supplies the first pull-up control signal BCR1 to the node voltage control unit CQ.

The pull-up control transistor BT of the first node voltage control unit CQ1 is turned on by the gate-on voltage VGH of the pull-up node Q, and supplies the pull-up control signal BCR1 from the display driving circuit 400 to the second electrode of the pull-up capacitor Cb. Accordingly, the pull-up capacitor Cb varies or maintains the voltage magnitude of the pull-up node Q connected to the first electrode depending on the voltage magnitude of the pull-up control signal BCR1 input to the second electrode.

The first and second output control units OUC1 and OUC2 simultaneously (or concurrently) output the n-th and n+1-th gate scan signals SCn+1 to the first and second gate lines through the n-th and n+1-th scan signal lines SCLn and SCLn+1, in response to the first and second line select signals SCK1 and SCK2 that are simultaneously (or concurrently) input for the first time during the enable period (or charging period) of the pull-up node Q.

The third and fourth output control units simultaneously (or concurrently) output the n+2-th and n+3-th gate scan signals to the third and fourth gate lines through the n+2-th and n+3-th scan signal lines, in response to the third and fourth line select signals that are simultaneously (or concurrently) input for the second time during the enable period of the pull-up node Q.

Next, the fifth and sixth output control units simultaneously (or concurrently) output the n+4-th and n+5-th gate scan signals SCn+4 and SCn+5 to the fifth and sixth gate lines through the n+4-th and n+5-th scan signal lines, in response to the fifth and sixth line select signals SCK5 and SCK6 that are simultaneously (or concurrently) input for the third time during the enable period of the pull-up node Q.

Next, the seventh and eighth output control units simultaneously (or concurrently) output the n+6-th and n+7-th gate scan signals to the seventh and eighth gate lines through the n+6-th and n+7-th scan signal lines, in response to the seventh and eighth line select signals that are simultaneously (or concurrently) input for the fourth time during the enable period of the pull-up node Q.

Next, the ninth and tenth output control units simultaneously (or concurrently) output the n+8-th and n+9-th gate scan signals to the ninth and tenth gate lines through the n+8-th and n+9-th scan signal lines, in response to the ninth and tenth line select signals SCK9 and SCK10 that are simultaneously (or concurrently) input for the fifth time during the enable period of the pull-up node Q.

Next, the eleventh and twelfth output control units simultaneously (or concurrently) output the n+10-th and n+11-th gate scan signals SCn+10 and SCn+11 to the eleventh and twelfth gate lines through the n+10-th and n+11-th scan signal lines, in response to the eleventh and twelfth line select signals SCK11 and SCK12 that are simultaneously (or concurrently) input for the fifth time during the enable period of the pull-up node Q.

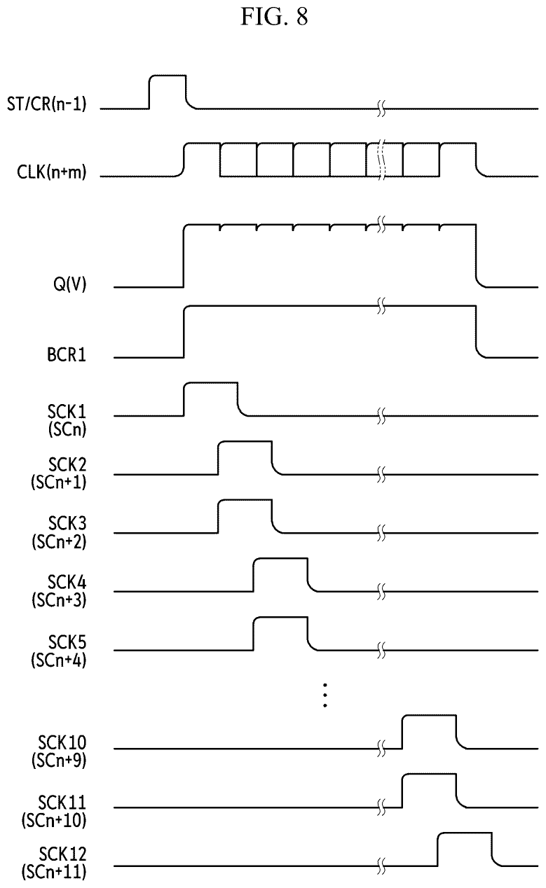

FIG. 8 is a waveform diagram illustrating signals input and output to the n-th stage and the output circuits and a voltage magnitude of a pull-up node during an even-numbered frame period.

Referring to FIGS. 6 and 8, an operation of the n-th stage STn during even-numbered frame periods is briefly described as follows.

During the even-numbered frame periods, first, the fourth transistor T4 is turned on in response to the stage select signal ES or the start signal ST of the sensing signal terminal RSI and supplies the gate-on voltage VGH to the pull-up node Q. Accordingly, the pull-up node Q is enabled.

When the pull-up node Q is enabled by the gate-on voltage VGH, the first transistor T1 is turned on and charges the first capacitor C1. As a result, the pull-up node Q may be bootstrapped.

The display driving circuit 400 generates a first pull-up control signal BCR1 with a voltage magnitude equal to the magnitude of the gate-on voltage VGH or greater than the gate-on voltage VGH during the period when the pull-up node Q of the n-th stage STn is enabled and supplies the first pull-up control signal BCR1 to the node voltage control unit CQ.

The pull-up control transistor BT of the first node voltage control unit CQ1 is turned on by the gate-on voltage VGH of the pull-up node Q, and supplies the pull-up control signal BCR1 from the display driving circuit 400 to the second electrode of the pull-up capacitor Cb. Accordingly, the pull-up capacitor Cb varies or maintains the voltage magnitude of the pull-up node Q connected to the first electrode depending on the voltage magnitude of the pull-up control signal BCR1 input to the second electrode.

During the even-numbered frame periods of the image display period, the display driving circuit 400 generates one first line select signal SCK1 with the magnitude of the gate-on voltage VGH for at least one horizontal period 1H and supplies the generated first line select signal SCK1 to one output control unit OUC1. Next, the display driving circuit 400 sequentially generates the 2n-th and 2n+1-th (even and odd-numbered) line select signals SCK2 and SCK3, SCK4 and SCK5, SCK6 and SCK7, SCK8 and SCK9, and SCK10 and SCK11 so that the 2n-th and 2n+1-th (even and odd-numbered) line select signals SCK2 and SCK3, SCK4 and SCK5, SCK6 and SCK7, SCK8 and SCK9, and SCK10 and SCK11 are paired and simultaneously (or concurrently) varied for each at least one horizontal period 1H with the magnitude of the gate-on voltage VGH. In addition, the display driving circuit 400 sequentially supplies the 2n-th and 2n+1-th (even and odd-numbered) line select signals SCK2 and SCK3, SCK4 and SCK5, SCK6 and SCK7, SCK8 and SCK9, and SCK10 and SCK11 that are simultaneously (or concurrently) and sequentially generated for each of the 2n-th and 2n+1-th (even and odd-numbered) to the 2n-th and 2n+1-th (even and odd-numbered) output control units OUC2 and OUC3, OUC4 and OUC5, OUC6 and OUC7, OUC8 and OUC9, and OUC10 and OUC11 each corresponding thereto. Next, the display driving circuit 400 generates one twelfth line select signal SCK12 with the magnitude of the gate-on voltage VGH for at least one horizontal period 1H and supplies the generated twelfth line select signal SCK12 to one twelfth output control unit OUC12.

Accordingly, the first output control unit OUC1 outputs the n-th gate scan signal SCn to the first gate line through the n-th scan signal line SCLn, in response to one first line select signal SCK1 that is firstly input during the enable period (or charging period) of the pull-up node Q.

Next, the second and third output control units OUC2 and OUC3 output the n+1-th and n+2-th gate scan signals SCn+1 and SCn+2 to the second and third gate lines through the second and third scan signal lines SCLn+1 and SCLn+2, in response to the 2n-th and 2n+1-th line select signals SCK2 and SCK3 that are simultaneously (or concurrently) supplied during the enable period of the pull-up node Q.

Next, the fourth and fifth output control units simultaneously (or concurrently) output the n+3-th and n+4-th gate scan signals to the fourth and fifth gate lines through the n+3-th and n+4-th scan signal lines, in response to the fourth and fifth line select signals that are simultaneously (or concurrently) input for the second time during the enable period of the pull-up node Q.

Next, the sixth and seventh output control units simultaneously (or concurrently) output the n+5-th and n+6-th gate scan signals to the sixth and seventh gate lines through the n+5-th and n+6-th scan signal lines, in response to the sixth and seventh line select signals that are simultaneously (or concurrently) input for the third time during the enable period of the pull-up node Q.

Next, the eighth and ninth output control units simultaneously (or concurrently) output the n+7-th and n+8-th gate scan signals to the eighth and ninth gate lines through the n+7-th and n+8-th scan signal lines, in response to the eighth and ninth line select signals that are simultaneously (or concurrently) input for the fourth time during the enable period of the pull-up node Q.

Next, the tenth and eleventh output control units OUC10 and OUC11 simultaneously (or concurrently) output the n+9-th and n+10-th gate scan signals SCn+9 and SCn+10 to the tenth and eleventh gate lines through the n+10-th and n+11-th scan signal lines, in response to the tenth and eleventh line select signals SCK10 and SCK11 that are simultaneously (or concurrently) input for the fifth time during the enable period of the pull-up node Q.

Next, the twelfth output control unit OUC12 outputs the n+11-th gate scan signal SCn+11 to the twelfth gate line through the n+11-th scan signal line SCLn+11, in response to one twelfth line select signal SCK12 that is lastly input during the enable period of the pull-up node Q.

In this way, the display driving circuit 400 generates the plurality of line select signals SCK1 to SCK12 so that the phases of the plurality of line select signals SCK1 to SCK12 are shifted in units of the odd and even-numbered frame periods, and supplies the generated signals to the plurality of output control units OUC1 to OUC12.

In concluding the detailed description, those skilled in the art will appreciate that many variations and modifications can be made to the disclosed embodiments without substantially departing from the spirit and scope of embodiments according to the present disclosure. Therefore, the disclosed embodiments of the present disclosure are used in a generic and descriptive sense only and not for purposes of limitation.

What is claimed is:

1. A display device comprising:
a plurality of pixels in a display area of a display panel;
a display driving circuit configured to control data voltages supplied to the plurality of pixels and image display timing of the pixels; and
a scan drive circuit configured to drive gate lines of the display panel,
wherein the scan drive circuit includes:
an n-th stage configured to enable a pull-up node for each of odd and even frame periods in response to gate control signals from the display driving circuit;
a plurality of output control units configured to share a pull-up node of the n-th stage and to supply gate scan signals to the gate lines in response to line select signals from the display driving circuit; and
a node voltage control unit configured to control a voltage magnitude of a gate-on voltage charged to the pull-up node during an enable period in response to a pull-up control signal from the display driving circuit.

2. The display device of claim 1, wherein the display driving circuit is configured to align digital image data input from an outside source into units of a number of frames corresponding to a resolution and half frequency of a frame driving frequency, to copy image data for each the number of frames corresponding to the half frequency and to arrange the image data in even-numbered frames to modulate and align a total number of frames to a same number as the frame driving frequency.

3. The display device of claim 1, wherein the display driving circuit is configured to generate the line select signals so that phases of the line select signals are differently shifted in units of the odd and even frame periods, and to supply the generated line select signals to the plurality of output control units in units of the odd and even frame periods.

4. The display device of claim 3, wherein the display driving circuit is configured to:
sequentially generate 2n−1-th and 2n-th line select signals so that the 2n−1-th and 2n-th (odd and even-numbered) line select signals are paired and simultaneously varied with a magnitude of the gate-on voltage during the odd frame periods, and
sequentially supply the 2n−1-th and 2n-th line select signals sequentially generated for each of the 2n−1-th and 2n-th to corresponding 2n−1-th and 2n-th output control units of the plurality of output control units, respectively.

5. The display device of claim 3, wherein the display driving circuit is configured to:
generate one first line select signal with a magnitude of the gate-on voltage during the even frame periods and supply the generated first line select signal to a first output control unit,
sequentially generate 2n-th and 2n+1-th line select signals so that the 2n-th and 2n+1-th (even and odd-numbered) line select signals are paired and simultaneously varied with the magnitude of the gate-on voltage,
sequentially supply the 2n-th and 2n+1-th line select signals generated sequentially to the corresponding 2n-th and 2n+1-th output control units, respectively, and
generate one last line select signal with the magnitude of the gate-on voltage and supply the generated last line select signal to one output control unit located at an end.

6. The display device of claim 3, wherein the plurality of output control units configured to share the pull-up node are configured to supply the gate scan signals to the gate lines in different orders for each of the odd and even frame periods, in response to the line select signals supplied in different orders for each of the odd and even frame periods during the enable period in which the gate-on voltage is applied to the pull-up node.

7. The display device of claim 6, wherein the plurality of output control units configured to share the pull-up node are configured to:
simultaneously supply gate scan signals in units of each pair of gate lines adjacent to each other at 2n−1-th and 2n-th (where n is a positive integer) in response to the line select signals during the odd frame periods, and sequentially supply the gate scan signals in the units of each pair of gate lines, and
output one gate scan signal to one gate line on a first horizontal line in response to the line selection signals during the even frame periods, simultaneously supply the gate scan signals in units of each pair of gate lines adjacent to each other at the 2n-th and 2n+1-th, sequentially supply the gate scan signals in the units of each pair of gate lines, and supply the gate scan signal to one gate line on a last horizontal line.

8. The display device of claim 6, wherein the plurality of output control units configured to share the pull-up node are configured to sequentially supply 2n−1-th and 2n-th gate scan signals to 2n−1-th and 2n-th gate lines, respectively, in response to the 2n−1-th and 2n-th line select signals, which are simultaneously supplied in pairs during the enable period of the odd frame periods, respectively.

9. The display device of claim 6, wherein during the enable period of the even frame periods, one of the plurality of output control units is configured to first supply a gate scan signal to a gate line of a first horizontal line in response to one line select signal generated for a first time,
2n-th and 2n+1-th output control units are configured to sequentially supply 2n-th and 2n+1-th gate scan signals in units of 2n-th and 2n+1-th gate lines, respectively, in response to 2n-th and 2n+1-th line select signals simultaneously supplied for each of the 2n-th and 2n+1-th, respectively, and
a last one output control unit is configured to supply a gate scan signal to one gate line on a last horizontal line in response to a last one line select signal.

10. A display device comprising:
a plurality of pixels in a display area of a display panel;
a display driving circuit configured to control data voltages supplied to the plurality of pixels and image display timing of the pixels; and
a scan drive circuit configured to drive gate lines of the display panel,
wherein the scan drive circuit includes:
an n-th stage configured to enable a pull-up node for each of odd and even frame periods in response to gate control signals from the display driving circuit;
a plurality of output control units configured to share a pull-up node of the n-th stage and to supply gate scan signals to the gate lines in response to line select signals from the display driving circuit; and
a node voltage control unit configured to control a voltage magnitude of a gate-on voltage charged to the pull-up node during an enable period in response to a pull-up control signal from the display driving circuit, and
the display driving circuit is configured to generate the line select signals so that phases of the line select signals are differently shifted for each of the odd and even frame periods, and to supply the generated line select signals to the plurality of output control units for each of the odd and even frame periods.

11. The display device of claim 10, wherein the display driving circuit is configured to align digital image data input from an outside source into units of a number of frames corresponding to a resolution and half frequency of a frame driving frequency, to copy image data for each the number of frames corresponding to the half frequency and to arrange the image data in even-numbered frames to modulate and align a total number of frames to a same number as the frame driving frequency.

12. The display device of claim 11, wherein the display driving circuit is configured to:
sequentially generate 2n−1-th and 2n-th line select signals so that the 2n−1-th and 2n-th (odd and even-numbered) line select signals are paired and simultaneously varied with a magnitude of the gate-on voltage during the odd frame periods, and
sequentially supply the 2n−1-th and 2n-th line select signals sequentially generated for each of the 2n−1-th and 2n-th to corresponding 2n−1-th and 2n-th output control units of the plurality of output control units, respectively.

13. The display device of claim 12, wherein the display driving circuit is configured to:
generate one first line select signal with the magnitude of the gate-on voltage during the even frame periods and supply the generated first line select signal to a first output control unit,
sequentially generate the 2n-th and 2n+1-th line select signals so that the 2n-th and 2n+1-th (even and odd-numbered) line select signals are paired and simultaneously varied with the magnitude of the gate-on voltage,
sequentially supply the 2n-th and 2n+1-th line select signals generated sequentially to the corresponding 2n-th and 2n+1-th output control units, respectively, and
generate one last line select signal with the magnitude of the gate-on voltage and supply the generated last line select signal to one output control unit located at an end.

14. The display device of claim 10, wherein the plurality of output control units configured to share the pull-up node are configured to supply the gate scan signals to the gate lines in different orders for each of the odd and even frame periods, in response to the line select signals supplied in different orders for each of the odd and even frame periods during the enable period in which the gate-on voltage is applied to the pull-up node.

15. The display device of claim 14, wherein the plurality of output control units sharing the pull-up node are configured to:
simultaneously supply gate scan signals in units of each pair of gate lines adjacent to each other at 2n−1-th and 2n-th (where n is a positive integer) in response to the line select signals during the odd frame periods, and sequentially supply the gate scan signals in the units of each pair of gate lines, and
output one gate scan signal to one gate line on a first horizontal line in response to the line selection signals during the even frame periods, simultaneously supply the gate scan signals in units of each pair of gate lines adjacent to each other at the 2n-th and 2n+1-th, sequentially supply the gate scan signals in the units of each pair of gate lines, and supply the gate scan signal to one gate line on a last horizontal line.

16. The display device of claim 15, wherein the plurality of output control units configured to share the pull-up node are configured to sequentially supply 2n−1-th and 2n-th gate scan signals to 2n−1-th and 2n-th gate lines, respectively, in response to the 2n−1-th and 2n-th line select signals, which are simultaneously supplied in pairs during the enable period of the odd frame periods, respectively.

17. The display device of claim 15, wherein during the enable period of the even frame periods, one of the plurality of output control units first is configured to supply a gate scan signal to a gate line of a first horizontal line in response to one line select signal generated for a first time,
2n-th and 2n+1-th output control units are configured to sequentially supply 2n-th and 2n+1-th gate scan signals in units of 2n-th and 2n+1-th gate lines, respectively, in response to 2n-th and 2n+1-th line select signals simultaneously supplied for each of the 2n-th and 2n+1-th, respectively, and
a last one output control unit is configured to supply a gate scan signal to one gate line located on a last horizontal line in response to a last one line select signal.

18. An electronic device including a display device, wherein the display device comprising:
a plurality of pixels in a display area of a display panel;
a display driving circuit configured to control data voltages supplied to the plurality of pixels and image display timing of the pixels; and
a scan drive circuit configured to drive gate lines of the display panel,
wherein the scan drive circuit includes:
an n-th stage configured to enable a pull-up node for each of odd and even frame periods in response to gate control signals from the display driving circuit;
a plurality of output control units configured to share a pull-up node of the n-th stage and supplying gate scan signals to the gate lines in response to line select signals from the display driving circuit; and
a node voltage control unit configured to control a voltage magnitude of a gate-on voltage charged to the pull-up node during an enable period in response to a pull-up control signal from the display driving circuit.
